(19) United States
(12) Patent Application Publication
(10) Pub. No.: US 2026/0057649 A1
(43) Pub. Date: Feb. 26, 2026

(54) SYSTEMS AND METHODS FOR DATA AUGMENTATION USING MEAN-FIELD GAMES

(71) Applicant: UNIVERSITY OF HOUSTON SYSTEM, Houston, TX (US)

(72) Inventors: Hien Van NGUYEN, Katy, TX (US); Zhu HAN, Sugar Land, TX (US); Yuhan KANG, Houston, TX (US)

(21) Appl. No.: 19/105,369

(22) PCT Filed: Sep. 20, 2023
(86) PCT No.: PCT/US2023/033221

§ 371 Date: Feb. 21, 2025

Related U.S. Application Data
(60) Provisional application No. 63/408,175, filed on Sep. 20, 2022.

(51) Int. Cl. G06V 10/774; G06V 10/82

(52) U.S. Cl. CPC G06V 10/774; G06V 10/82

(57) ABSTRACT

A system for image augmentation includes a processor and a memory. The memory includes instructions stored thereon, which when executed by the processor cause the system to access a first image and a second image, generate a path including points, perform a time-continuous transformation of a first distribution of pixels of the first image to a second distribution of pixels of the second image within a time interval along the path based on a mean-field game, and generate an augmented dataset based on the time-continuous transformation. The points start from the first image and end at the second image. The points include augmented images. The augmented images retain a shape of the first image and the second image.

### CROSS REFERENCE TO RELATED APPLICATION

This application claims the benefit of and priority to U.S. Provisional Patent Application Ser. No. 63/408,175, filed on Sep. 20, 2022, the entire contents of which are incorporated by reference herein.

### TECHNICAL FIELD

The present disclosure relates to systems and methods for data augmentation, specifically for data augmentation using mean-field games.

### BACKGROUND

The technology industry has become more reliant on machine learning systems to solve problems once exclusive to human participation. Such reliance is predicated on the system's capacity to continuously provide accurate and predictable results to tangible problems. Machines are taught through continuous exposure to training data sets, and there exists a pressing need to not only provide systems with a greater volume of data, but to offer data with greater diversity and affinity.

### SUMMARY

An aspect of the present disclosure provides a system for image augmentation which includes a processor and a memory. The memory includes instructions stored thereon, which, when executed by the processor, cause the system to: access a first image and a second image; generate a path including points; perform a time-continuous transformation of a first distribution of pixels of the first image to a second distribution of pixels of the second image within a time interval along the path based on a mean-field game; and generate an augmented dataset based on the time-continuous transformation. The points start from the first image and end at the second image. The points include augmented images. The augmented images retain a shape of the first image and the second image.

In an aspect of the present disclosure, the instructions, when executed by the processor may further cause the system to train a machine learning network. The machine learning network may be trained using the augmented dataset.

In another aspect of the present disclosure, the time-continuous transformation may further include performing a minimization function to minimize error during the transformation of the first distribution of pixels of the first image to the second distribution of pixels of the second image.

In an aspect of the present disclosure, the instructions, when executed by the processor, may further cause the system to compare a first pixel to a second pixel to generate output including at least one of an object value or an edge shape value.

An aspect of the present disclosure provides a computer-implemented method for feature augmentation. The computer-implemented method includes accessing a first dataset and a second dataset, generating a path including points of augmented data which start from the first dataset and end at the second dataset, performing a time-continuous transformation of a first distribution of features of the first dataset, to a second distribution of features of the second dataset within a time interval along the path based on a mean-field game, generating an augmented dataset based on the time-continuous transformation, and training a machine learning model by using the augmented dataset as a training data set.

In an aspect of the present disclosure, the augmented dataset may further include a multi-dimensional dataset.

In another aspect of the present disclosure, the computer-implemented method may further include using a generative machine learning network to reduce a dimension of the multi-dimensional dataset.

In an aspect of the present disclosure, the computer-implemented method may further include using a discriminative machine learning network to evaluate the lower-dimensional dataset by minimizing error.

In another aspect of the present disclosure, the path generated is a manifold of low dimensional feature space.

In an aspect of the present disclosure, the computer-implemented method may further include limiting a rate at which the first distribution of features of the first dataset alters into the second distribution of features of the second dataset using a control function, and applying a penalty to the control function.

In another aspect of the present disclosure, the computer-implemented method may further include applying a terminal condition to the path of the first distribution of features of the first dataset altering into the second distribution of features of the second dataset, and applying an optimality condition to a discriminator to determine whether the transformation of the first distribution of data points of the first dataset altering into the second distribution of data points of the second dataset is identical.

In an aspect of the present disclosure, the computer-implemented method may further include generating the path with a generator and analyzing whether the path has satisfied the optimality condition using a discriminator.

In another aspect of the present disclosure, the first distribution of features of the first dataset may further include at least one of a label-variant transformation or a label-agnostic transformation and the second distribution of features of the second dataset includes at least one of a label-variant transformation or a label-agnostic transformation.

In an aspect of the present disclosure, the computer-implemented method may further include converting the first distribution of features of the first dataset into a first dimensional feature space distribution and the distribution of features of the second dataset into a second dimensional feature space distribution, generating a set of minimized path data points by altering the first dimensional feature space distribution to render the second dimensional feature space distribution by performing a minimization function, applying the terminal condition and the discriminator to ensure the set of minimized path data points satisfy the optimality condition, creating a set of augmented image features from the minimized path data points, producing a training data set including the created set of augmented image features, and training a machine learning network with the set of augmented image features by using the training data set.

An aspect of the present disclosure provides a computer-implemented method for generating augmented data. The computer-implemented method includes accessing a first data file and a second data file of two or more dimensions, transforming the first data file and the second data file to a first distribution of data points of the first data file and a second distribution of data points of the second data file, performing a time-continuous transformation of the first distribution of data points of the first data file to the second distribution of data points of the second data file on a continuous path, generating a set of path data points from the continuous path which includes a manifold of data distribution from the transformation of the first distribution of data points of the first data file to the second distribution of data points of the second data file, and constructing an augmented dataset from the set of path data points.

In an aspect of the present disclosure, the first data file may further include a first image, and the second data file may further include a second image.

In another aspect of the present disclosure, the computer-implemented method may further include converting the first image into a first pixel value space distribution and the second image into a second pixel value space distribution, generating a set of minimized path data points by altering the first pixel value space distribution to render the second image pixel value space distribution by performing a minimization function, creating a set of augmented images from the minimized path data points, producing a training dataset wherein the dataset includes the augmented dataset, and training a machine learning network with the augmented dataset by using the training dataset.

In an aspect of the present disclosure, the continuous path may further include a manifold of pixel values.

In another aspect of the present disclosure, the computer-implemented method may further include calculating a distance between a first pixel value space distribution location on the manifold and a second pixel value space distribution location on the manifold using a divergence function. The converting of the first pixel value space distribution into the second pixel value space distribution is governed by a target image distribution.

In an aspect of the present disclosure, the target image distribution may further govern the transformation of the first pixel value space distribution by breaking the path into sub-step locations on the manifold.

An aspect of the present disclosure provides a system for feature augmentation. The system includes a processor and a memory, including instructions stored thereon. The instructions when executed by the processor cause the system to: access a first dataset and a second dataset; generate a path including points, wherein the points start from the first dataset and end at the second dataset; perform a time-continuous transformation of a first distribution of features of the first dataset, to a second distribution of features of the second dataset within a time interval along the path based on a mean-field game, wherein the points include augmented data; generate an augmented dataset based on the time-continuous transformation; and train a machine learning model by using the augmented dataset as a training data set.

In an aspect of the present disclosure, the augmented dataset may be a multi-dimensional dataset.

In an aspect of the present disclosure, the instructions, when executed by the processor may further cause the system to use a generative machine learning network to reduce a dimension of the multi-dimensional dataset.

In an aspect of the present disclosure, the instructions, when executed by the processor may further cause the system to use a discriminative machine learning network to evaluate the lower-dimensional dataset by minimizing error.

In an aspect of the present disclosure, the path generated may be a manifold of low dimensional feature space.

In an aspect of the present disclosure, the instructions, when executed by the processor may further cause the system to: limit a rate at which the first distribution of features of the first dataset alters into the second distribution of features of the second dataset using a control function; and apply a penalty to the control function.

In an aspect of the present disclosure, the instructions, when executed by the processor may further cause the system to: apply a terminal condition to the path of the first distribution of features of the first dataset altering into the second distribution of features of the second dataset; and apply an optimality condition to a discriminator to determine whether the transformation of the first distribution of data points of the first dataset altering into the second distribution of data points of the second dataset is identical.

In an aspect of the present disclosure, the instructions, when executed by the processor further cause the system to: generate the path with a generator; and analyze whether the path has satisfied the optimality condition using a discriminator.

In an aspect of the present disclosure, the first distribution of features of the first dataset may include at least one of a label-variant transformation or a label-agnostic transformation and the second distribution of features of the second dataset includes at least one of a label-variant transformation or a label-agnostic transformation.

In an aspect of the present disclosure, the instructions, when executed by the processor may further cause the system to: convert the first distribution of features of the first dataset into a first dimensional feature space distribution and the distribution of features of the second dataset into a second dimensional feature space distribution.

In an aspect of the present disclosure, the instructions, when executed by the processor may further cause the system to: generate a set of minimized path data points by altering the first dimensional feature space distribution to render the second dimensional feature space distribution by performing a minimization function.

In an aspect of the present disclosure, the instructions, when executed by the processor may further cause the system to: apply the terminal condition and the discriminator to ensure the set of minimized path data points satisfy the optimality condition.

In an aspect of the present disclosure, the instructions, when executed by the processor may further cause the system to: create a set of augmented image features from the minimized path data points.

In an aspect of the present disclosure, the instructions, when executed by the processor may further cause the system to: produce a training data set comprising the created set of augmented image features.

In an aspect of the present disclosure, the instructions, when executed by the processor may further cause the system to: train a machine learning network with the set of augmented image features by using the training data set.

Further details and aspects of the present disclosure are described in more detail below with reference to the appended drawings.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a diagram of an exemplary networked environment for data augmentation, in accordance with examples of the present disclosure;

FIG. 2 is a block diagram of a controller configured for use with the system for data augmentation of FIG. 1, in accordance with aspects of the disclosure;

FIG. 3 is a block diagram of a machine learning network with inputs and outputs of a deep learning neural network, in accordance with aspects of the present disclosure;

FIG. 4 is a diagram of layers of the machine learning network of FIG. 3, in accordance with aspects of the present disclosure;

FIG. 5 is a flow diagram of a computer-implemented method for data augmentation, in accordance with aspects of the present disclosure;

FIG. 6 is a graphical representation of two distributions of data, augmented data, and corresponding path data points, in accordance with aspects of the present disclosure;

FIG. 7 is an illustration of training data results using a label-variant transformation in image-level augmentation, in accordance with aspects of the present disclosure;

FIG. 8 is an illustration of training data results using a label-agnostic transformation in image-level augmentation, in accordance with aspects of the present disclosure;

FIG. 9 is an illustration of training data results using a label-variant transformation in feature-level augmentation, in accordance with aspects of the present disclosure; and

FIG. 10 is an illustration of training data results using a label-agnostic transformation in feature-level augmentation, in accordance with aspects of the present disclosure.

### DETAILED DESCRIPTION

The present disclosure relates to systems and methods for data augmentation, specifically for data augmentation using mean-field games.

Aspects of the present disclosure are described in detail with reference to the drawings wherein like reference numerals identify similar or identical elements.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

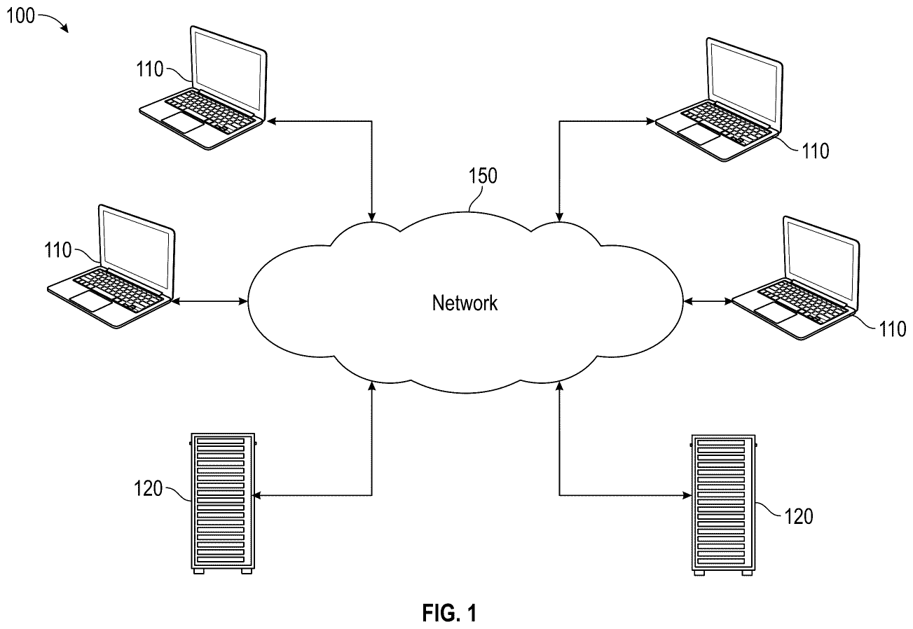

Referring to FIG. 1 an exemplary networked system 100 for generating augmented data is shown. The networked system 100 includes one or more computer systems 110, one or more servers 120, and a network 150. The computer systems 110 communicate with the servers 120 across the network 150 with regard to the augmented data. In various embodiments, the server 120 may store augmented data sets for the computer systems 110 to utilize as training data sets. In various embodiments, the computer systems 110 can generate new augmented data sets and communicate these sets back to the server 120 across the network 150.

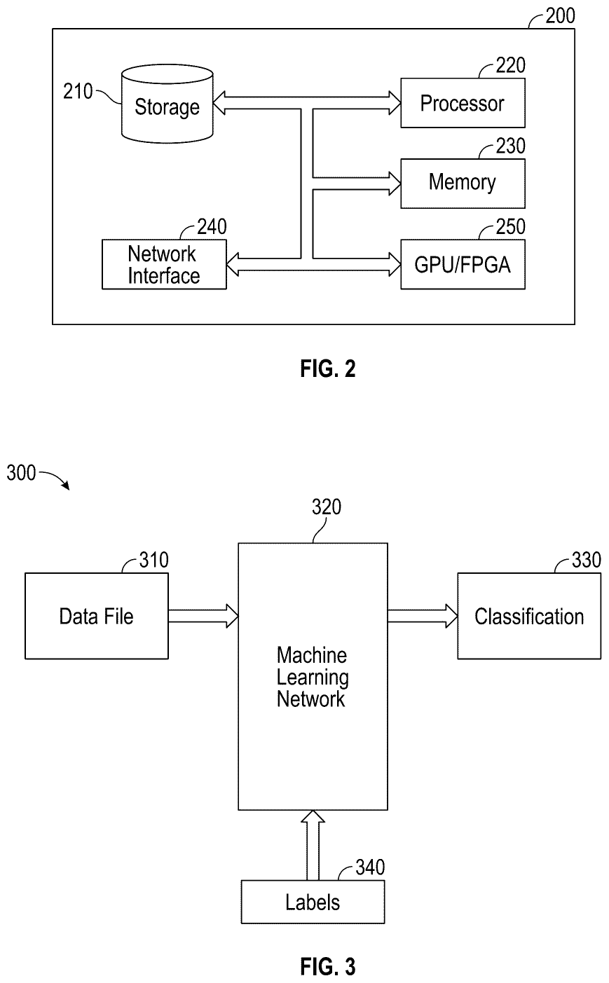

FIG. 2 illustrates controller 200 which includes a processor 220 connected to a computer-readable storage medium or a memory 230. The controller 200 may be used to control and/or execute operations of the networked system 100. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data. The disclosed method may run on the controller 200 or on a user device, including, for example, on a mobile device, an IoT device, or a server system.

With reference to FIG. 3, a block diagram for a machine learning network 320 for classifying data in accordance with some aspects of the disclosure is shown. In some systems, a machine learning network 320 may include, for example, a convolutional neural network (CNN) and/or a recurrent neural network. A deep learning neural network includes multiple hidden layers. As explained in more detail below, the machine learning network 320 may leverage one or more classification models (e.g., CNNs, decision trees, Naive Bayes, k-nearest neighbor) to classify data. The machine learning network 320 may be executed on the controller 200 (FIG. 2). Persons of ordinary skill in the art will understand the machine learning network 320 and how to implement it.

In machine learning, a CNN is a class of artificial neural network (ANN), most commonly applied to analyzing visual imagery. The convolutional aspect of a CNN relates to applying matrix processing operations to localized portions of an image, and the results of those operations (which can involve dozens of different parallel and serial calculations) are sets of many features that are delivered to the next layer. A CNN typically includes convolution layers, activation function layers, deconvolution layers (e.g., in segmentation networks), and/or pooling (typically max pooling) layers to reduce dimensionality without losing too many features. Additional information may be included in the operations that generate these features. Providing unique information that yields features that give the neural networks information can be used to provide an aggregate way to differentiate between different data input to the neural networks.

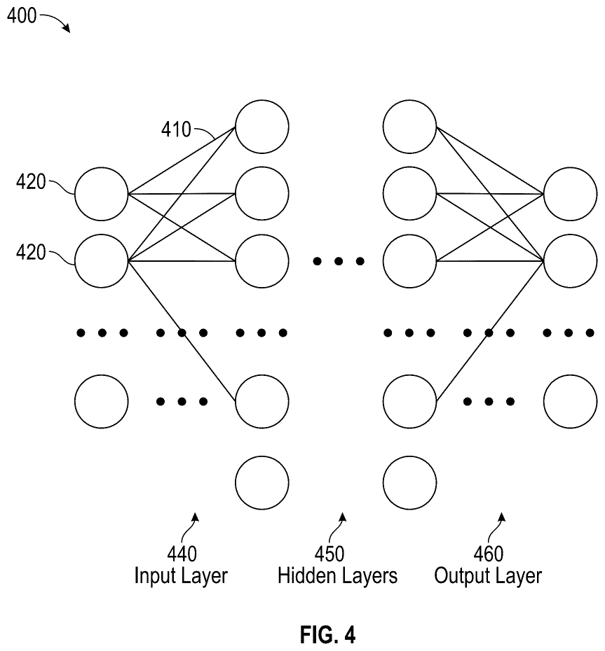

Referring to FIG. 4, generally, a machine learning network 320 (e.g., a convolutional deep learning neural network) includes at least one input layer 440, a plurality of hidden layers 450, and at least one output layer 460. The input layer 440, the plurality of hidden layers 450, and the output layer 460 all include neurons 420 (e.g., nodes). The neurons 420 between the various layers are interconnected via weights 410. Each neuron 420 in the machine learning network 320 computes an output value by applying a specific function to the input values coming from the previous layer. The function that is applied to the input values is determined by a vector of weights 410 and a bias. Learning, in the deep learning neural network, progresses by making iterative adjustments to these biases and weights. The vector of weights 410 and the bias are called filters (e.g., kernels) and represent particular features of the input (e.g., a particular shape). The machine learning network 320 may output logits. Although CNNs are used as an example, other machine learning classifiers are contemplated.

The machine learning network 320 may be trained based on labeling training data to optimize weights. For example, samples of image feature data may be taken and labeled using other image feature data. In some methods in accordance with this disclosure, the training may include supervised learning or semi-supervised. Persons of ordinary skill in the art will understand training the machine learning network 320 and how to implement it.

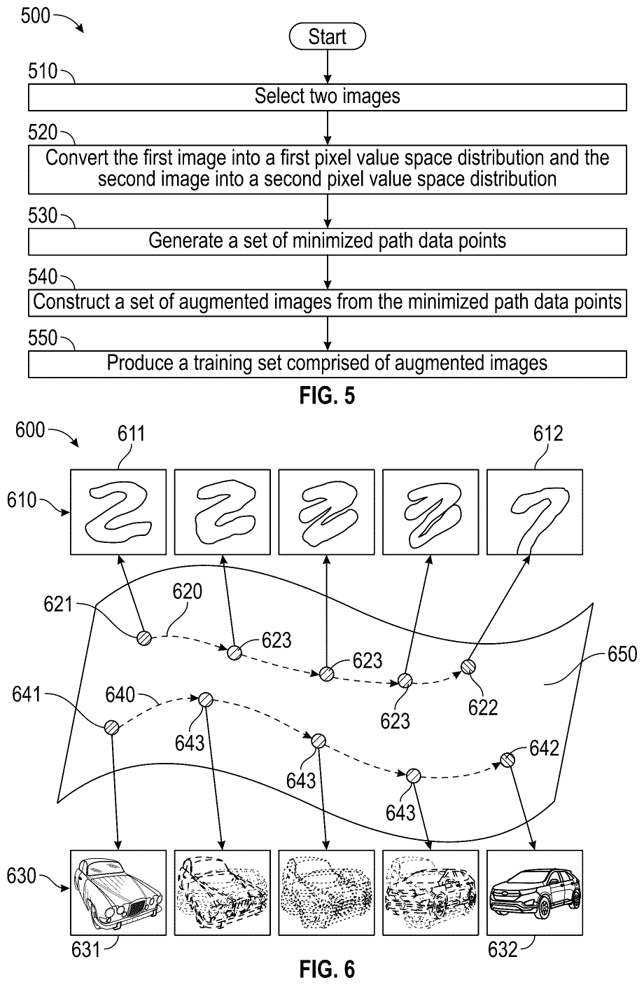

Referring to FIG. 5, a flow diagram for a method in accordance with the present disclosure for generating augmented data is shown as 500. Although the steps of FIG. 5 are shown in a particular order, the steps need not all be performed in the specified order, and certain steps can be performed in another order. For example, FIG. 5 will be described below, with a controller 200 of FIG. 2 performing the operations. In aspects, the operations of FIG. 5 may be performed all or in part by another device, for example, a server, and/or a computer system. These variations are contemplated to be within the scope of the present disclosure.

Initially, at step 510, the controller 200 selects two images. In aspects, the images may be stored in a database. It is contemplated that the controller 200 may select more than two images, for example, four images may be selected. In aspects, other data files may be used in the steps of method 500, for example, medical data files.

Next, at step 520, the controller 200 converts the first image into a first pixel value space distribution and the second image into a second pixel value space distribution. In aspects, the controller 200 may convert the first image into a first distribution of features of the first dataset and the second image into a second distribution of features of the second dataset.

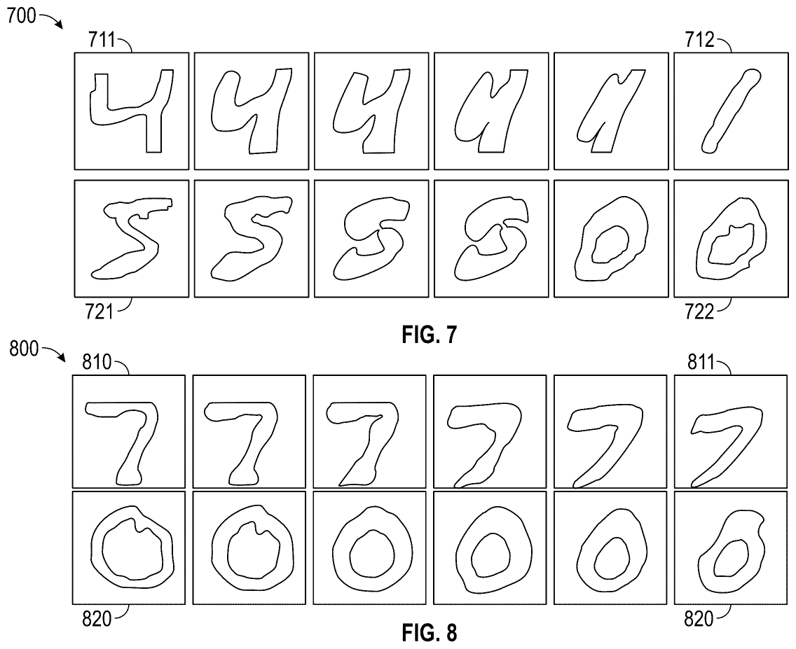

Next, at step 530, the controller 200 generates a set of minimized path data points 620 (FIG. 6) by transforming the first pixel value space distribution to render the second image pixel value space distribution by performing a minimization function. In aspects, the transformation may include a time continuous minimization function set to minimize error during the transformation in tandem with a control algorithm which may further compare a first pixel to a second pixel to generate an output including at least one of an object value or an edge shape value.

In aspects, the controller 200 may generate a set of minimized path data points by transforming the first distribution of features of the first dataset to render the second distribution of features of the second dataset by performing a minimization function. In aspects, the transformation may include use of a generative machine learning network to improve the dimensionality within the dataset. For example, the controller 200 may use a generative machine learning network to reduce a dimension of a multi-dimensional dataset. A discriminative machine learning network may be used in tandem with the generative machine learning network to further evaluate the dataset and minimize error. In aspects, a terminal condition and an optimality condition are applied to the transformation. As used herein, the term terminal condition includes a user-defined attribute to cease transformation. As used herein, the term optimality condition includes a user-defined attribute to govern conformity during and after the transformation.

Next, at step 540, the controller 200 constructs a set of augmented images from the minimized path data points. In aspects, the minimized path may apply a mean-field game augmentation. A typical mean-field game model consists of a large number of agents denoted by A={a₁, a₂, . . . , aₖ}. The following stochastic equation may govern the agent dynamics:

$${dX}^{k} ( t ) = f ( {α}^{k} ( t ) ) dt + σ {dW}^{k} ( t ) , {X}^{k} ( 0 ) = {x}_{0}^{k} , \qquad ( Eqn . 1 )$$

where X^{k}(t) is the state of agent aₖ at time t, aₖ(t) is the control input, and

$${x}_{0}^{k}$$

the initial state of agent aₖ at time t=0. W^{k}(t) is a Brownian motion that captures agent's stochastic property, and σ is its intensity. Under the dynamics constraint, agents aims to minimize the cost in the time interval [0,T] by finding their optimal strategy α*(t):

$${min}_{α ( t )} {J}_{k} = 𝔼 [ {\int }_{0}^{T} L ( α ( t ) , {X}^{k} ( t ) , ρ ( t ) ) d t + G ( {X}^{k} ( T ) , ρ ( T ) ) ] , \qquad ( Eqn . 2 )$$

where ρ(t) is the distribution of agents' state at time t, known as the mean-field term in mean-field game theory. Here, L(α(t),X^{k}(t),ρ(t)) is known as the running cost, since the running cost is generated continuously in the time interval [0,T], and G(X^{k}(T),ρ(T)) is known as terminal cost, since the terminal cost is generated only at the terminal time T. The agent's optimal strategy α*(t) is given by solving the mentioned mean-field game problem.

Each point on the path includes an augmented image, with each image retaining a shape of the first image and the second image. In aspects, the minimized path is a manifold of pixel values. As used herein, the term manifold includes the collection of data of each iteration when transforming the first distribution of features into the second distribution of features. The manifold provides a representation of features to be used in data augmentation. In aspects, the minimized path is a manifold of low dimensional feature space. In aspects, the minimized path is generated with a generator that analyzes whether the minimized path has satisfied the optimality condition using a discriminator. In aspects, the minimized path includes calculating a distance using a divergence function, where the distance is equal to a difference between the first pixel value space distribution location on the manifold and the second pixel value space distribution location on the manifold. The divergence function governs the conversion of the first pixel value space distribution into the second pixel value space distribution with a target image distribution. The target distribution governs the transformation of the first pixel value space distribution by breaking the path into a sub-step locations on the manifold.

Next, at step 550, the controller 200 produces a training set from the augmented images. In aspects, the augmented images may be used to train a machine learning network. The augmented images have diversity scores over approximately two and affinity scores over about 0.8. As used herein, the term diversity score includes a quantifying metric for the machine learning model that measures the complexity of the augmented data with respect to the model and learning procedure. As used herein, the term affinity score includes a quantifying metrics for the machine learning model that measures how much an augmentation shifts the training data distribution from that learned by a model.

FIG. 6 shows two examples of the method in accordance with the present disclosure for generating augmented data of FIG. 5. The method in 610 demonstrates accessing two images, converting the images into two pixel value spaces, performing a minimization function to render the pixel value space of image two starting from image one, and generating augmented data from the minimized path. Mean field game augmentation may transform the first image's pixel distribution 621 into another image's pixel distribution 622 along a path 620 so that the points 623 along the path 620 are augmented images. In aspects, the augmented images and features may be used to train a machine learning network.

For example, let xₖ(t), k=1, 2, . . . , N, be the k-th pixel of an image, where N is the image size. To allow the image to be represented as a distribution over the pixel value space of the image, the distribution of an image's pixels, denoted as ρᵢₙᵢₜᵢₐₗ(x) is transformed into the distribution of another image's pixels ρ_{Target}(x) within a time interval [0,T] along a “path” ρ*(t,x). Images are generated by sampling from the “path.” The initial point (i.e., when t=0) is the initial images' pixel distribution:

$$ρ ( 0 , x ) = {ρ}_{Initial} ( x ) . \qquad ( Eqn . 3 )$$

To control the transformation direction of the “path,” a control variable uₖ(t) is defined that can change pixels' value. The controlling process is described by:

$$d {x}_{k} ( t ) = {u}_{k} ( t ) dt . \qquad ( Eqn . 4 )$$

To summarize the global information of all pixels, a mean-field term, i.e., the distribution of the image's pixels as ρ(t,x), is defined. Then, dynamics in Eqn. 4 are transformed into its distribution dynamics:

$${\partial }_{t} ρ ( t , x ) + ∇ \cdot ( ρ ( t , x ) u ( t , x ) ) = 0 , \qquad ( Eqn . 5 )$$

where ∂ is the partial derivative operator, and ∇ is the divergence operator. u(t) is transformed into a field control u(t,x).

The image is prevented from changing too fast along the path ρ(t,x), to ensure the augmented images in adjacent time slots in the “path” share a certain similarity. To do so, the cost function is quantified by imposing a penalty on the L2-norm of the control function. The overall mean-field game augmentation problem in image-level is given as follows:

$${min}_{u , ρ} J = {\int }_{0}^{T} {\int }_{Ω} ρ ( t , x ) {‖ u ( t , x ) ‖}_{2}^{2} dxdt + KL ( ρ ( T , x ) ‖ {ρ}_{Target} ( x ) ) \qquad ( Eqn . 6 )$$

$$s . t . \{ \begin{matrix}{\partial }_{t} ρ ( t , x ) + ∇ \cdot ( ρ ( t , x ) u ( t , x ) ) = 0 , \\ ρ ( 0 , x ) = {ρ}_{Initial} .\end{matrix} \qquad ( Eqn . 7 )$$

where Ω is the pixel value space, i.e., Ω=[0,255], of the images. KL is the Kullback-Leibler (KL) divergence that quantifies the distance between the final point in the path ρ(T,x) and the target image's distribution ρ_{Target}, so that the path ρ(t,x) can move towards the target distribution ρ_{Target}.

The method in 630 demonstrates accessing two image features, converting the image features into two image feature distributions, performing a minimization function to render the image feature space of image two starting from image one, and generating augmented data from the minimized path. Mean field game augmentation is applied to transform the first image's set of features 641 into another image's set of features 642 along a path 640 so that the points 643 along the path 640 are a set of augmented features. In aspects, the augmented images and features may be used to train a machine learning network.

For example, let sₖ(t), k=1, 2, . . . , N, be the learned features of the k-th image in a dataset, where N is the dataset size and t is time. Mean-field game augmentation transforms a distribution of a set of images' features that includes N₁ images, denoted as ρᵢₙᵢₜᵢₐₗ(s), to another distribution of a set of images' features that includes N₂ samples (N₁+N₂=N), denoted as ρ_{Target}(s), along an optimized “path” ρ*(t,s) within a time interval [0,T], so that the points in such “path” are all augmented features. The optimized “path” is the exact manifold of the images in their latent space (see FIG. 6).

The initial point (t=0) and the final point (t=T) of the path ρ(t,s) is the distribution of the initial set of features and the distribution of the target set of features:

$$ρ ( 0 , s ) = {ρ}_{Initial} ( s ) , \qquad ( Eqn . 8 )$$

$$ρ ( T , s ) = {ρ}_{Target} ( s ) . \qquad ( Eqn . 9 )$$

To control the transformation direction of the “path,” a control variable u(t) is defined to control the flow of the distribution of features. The controlling process is described by:

$$d {s}_{k} ( t ) = {u}_{k} ( t ) dt . \qquad ( Eqn . 10 )$$

Different from the mean-field game augmentation in image-level augmentation in Eqn. 6, the terminal condition of the path ρ(t,s) in Eqn. 9 imposes a hard constraint to enforce the final point in the path to be exactly the target distribution of features. This is because the KL divergence may be meaningless when the sampled features from β_{Target}(s) are sparse and discrete, which may result in gradient vanishing and make the KL divergence unstable to derive the optimal manifold ρ(t,s). Note that in such formulation, the cost function in Eqn. 11 becomes a Wasserstein-2 distance.

Similar to image-level augmentation, a “smooth” path is generated between two distributions. An L-2 norm penalty is imposed on the control in the cost function, and the overall feature-level mean-field game augmentation is:

$${min}_{u , ρ} J = {\int }_{0}^{T} {\int }_{Ω} ρ ( t , s ) {‖ u ( t , s ) ‖}_{2}^{2} dsdt \qquad ( Eqn . 11 )$$

$$s . t . \{ \begin{matrix}{\partial }_{t} ρ ( t , s ) + ∇ \cdot ( ρ ( t , s ) u ( t , s ) ) = 0 , \\ ρ ( 0 , s ) = {ρ}_{Initial} , \\ ρ ( T , s ) = {ρ}_{Target} ,\end{matrix} \qquad ( Eqn . 12 )$$

where Ω is the image's feature space (i.e., the latent space).

The mean-field game problem in Eqn. 11 may include a high-dimensional problem because the learned features may include hundreds or thousands of dimensions. The grid-based numerical methods, such as PDHG and Adjoint method, are prone to the curse of dimensionality, i.e., their computational complexity grows exponentially with spatial dimension. Thus, an APAC-Net, an alternating population and agent control neural network approach, is used for high-dimensional mean-field game problem. In particular, Eqn. 11 is solved by training a Wasserstein Generative Adversarial Network (WGAN) network. The mean-field game problem is first transformed into the Lagrangian problem:

$${min}_{ρ , u} {max}_{ϕ} \{ ℒ \} = {\int }_{0}^{T} {\int }_{Ω} ρ ( t , s ) {‖ u ( t , s ) ‖}_{2}^{2} - ϕ ( t , x ) ( {\partial }_{t} ρ ( t , s ) + ∇ \cdot ( ρ ( t , s ) u ( t , s ) ) ) dsdt . \qquad ( Eqn . 13 )$$

Eqn. 13 may be solved by training a WGAN neural network named APAC-Net. The neural network generator is denoted by G_{θ}(s,t), and the discriminator is denoted by N_{ω}(s,t). The generator generates the path (i.e., the manifold), and the discriminator judges whether the generated path satisfies the optimality condition:

$${ϕ}_{ω} ( z , t ) = ( 1 - t ) {N}_{ω} ( z , t ) , \qquad ( Eqn . 14 )$$

$${G}_{θ} ( s , t ) = ( 1 - t ) {s}_{0} + t ( 1 - t ) {N}_{θ} ( s , t ) + {ts}_{1} , \qquad ( Eqn . 15 )$$

where s₀˜ρᵢₙᵢₜᵢₐₗ are samples drawn from the initial distribution ρᵢₙᵢₜᵢₐₗ, and s₁˜ ρ_{Target} are samples drawn from the target distribution. It is noted that the formulation of G_{θ}(s,t) automatically encodes the boundary conditions in Eqn. 8 and Eqn. 9.

FIGS. 7-10 show examples of data augmentation using mean field game augmentation. Referring to FIG. 7, the label-variant mean field game augmentation in image-level augmentation 710 demonstrates an example of transforming an image of the number 4 into an image of the number 1 and transforming an image of the number 5 into an image of the number 0.

Referring to FIG. 8, the label-agnostic mean field game augmentation in image level augmentation 720 demonstrates an example of transforming an image of the number 7 into a different image of the number 7 and transforming an image of the number 0 into a different image of the number 0.

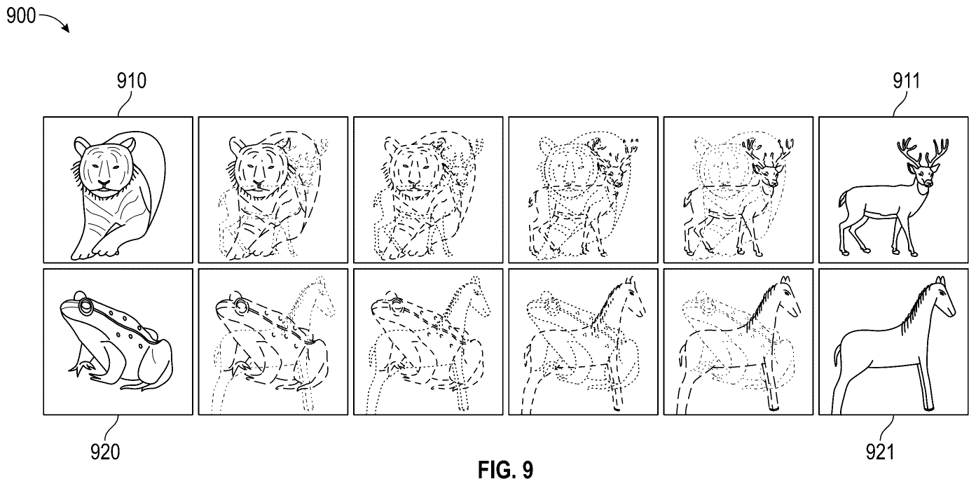

Referring to FIG. 9, the label-variant mean field game augmentation in feature-level augmentation demonstrates an example of transforming an image of a cat into an image of a deer and transforming an image of a frog into an image a horse.

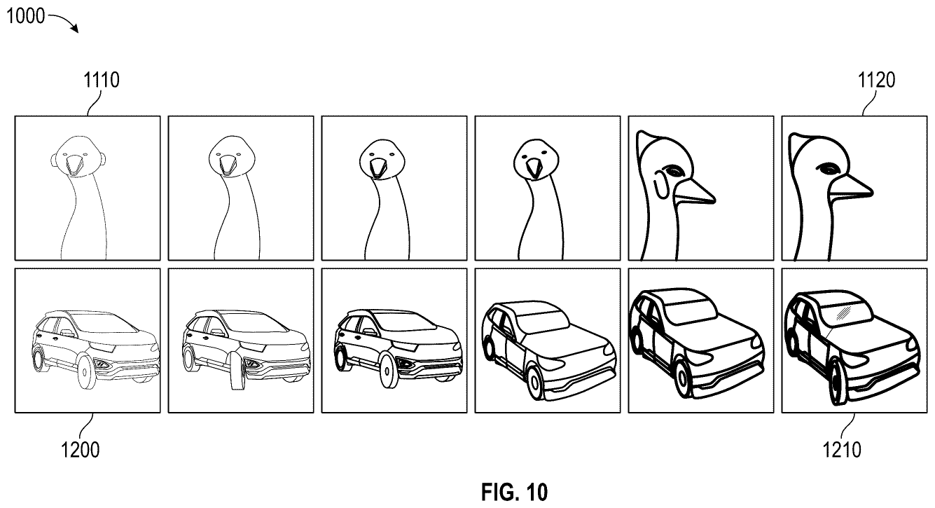

Referring to FIG. 10, the label-agnostic mean field game augmentation in feature-level augmentation demonstrates an example of transforming an image of a bird into a different image of a bird and transforming an image of a car into a different image of a car.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for image augmentation, the system comprising:
a processor; and
a memory, including instructions stored thereon, which when executed by the processor cause the system to:
access a first image and a second image;
generate a path including points, wherein the points start from the first image and end at the second image;
perform a time-continuous transformation of a first distribution of pixels of the first image to a second distribution of pixels of the second image within a time interval along the path based on a mean-field game, wherein the points include augmented images, and wherein the augmented images retain a shape of the first image and the second image; and
generate an augmented dataset based on the time-continuous transformation.

2. The system of claim 1, wherein the instructions, when executed by the processor further cause the system to train a machine learning network, wherein the machine learning network is trained using the augmented dataset.

3. The system of claim 1, wherein the time-continuous transformation includes performing a minimization function to minimize error during the transformation of the first distribution of pixels of the first image to the second distribution of pixels of the second image.

4. The system of claim 1, wherein the instructions, when executed by the processor further cause the system to compare a first pixel to a second pixel to generate output including at least one of an object value or an edge shape value.

5. A computer-implemented method for feature augmentation, comprising:
accessing a first dataset and a second dataset;
generating a path including points, wherein the points start from the first dataset and end at the second dataset;
performing a time-continuous transformation of a first distribution of features of the first dataset, to a second distribution of features of the second dataset within a time interval along the path based on a mean-field game, wherein the points include augmented data;
generating an augmented dataset based on the time-continuous transformation; and
training a machine learning model by using the augmented dataset as a training data set.

6. The computer-implemented method of claim 5, wherein the augmented dataset is a multi-dimensional dataset.

7. The computer-implemented method of claim 6, further comprising using a generative machine learning network to reduce a dimension of the multi-dimensional dataset.

8. The computer-implemented method of claim 7, further comprising using a discriminative machine learning network to evaluate the lower-dimensional dataset by minimizing error.

9. The computer-implemented method of claim 5, wherein the path generated is a manifold of low dimensional feature space.

10. The computer-implemented method of claim 5, further comprising:
limiting a rate at which the first distribution of features of the first dataset alters into the second distribution of features of the second dataset using a control function; and
applying a penalty to the control function.

11. The computer-implemented method of claim 5, further comprising:
applying a terminal condition to the path of the first distribution of features of the first dataset altering into the second distribution of features of the second dataset; and
applying an optimality condition to a discriminator to determine whether the transformation of the first distribution of data points of the first dataset altering into the second distribution of data points of the second dataset is identical.

12. The computer-implemented method of claim 11, further comprising:
generating the path with a generator; and
analyzing whether the path has satisfied the optimality condition using a discriminator.

13. The computer-implemented method of claim 5, wherein the first distribution of features of the first dataset includes at least one of a label-variant transformation or a label-agnostic transformation and the second distribution of features of the second dataset includes at least one of a label-variant transformation or a label-agnostic transformation.

14. The computer-implemented method of claim 11, further comprising:
converting the first distribution of features of the first dataset into a first dimensional feature space distribution and the distribution of features of the second dataset into a second dimensional feature space distribution;
generating a set of minimized path data points by altering the first dimensional feature space distribution to render the second dimensional feature space distribution by performing a minimization function;
applying the terminal condition and the discriminator to ensure the set of minimized path data points satisfy the optimality condition;
creating a set of augmented image features from the minimized path data points;
producing a training data set comprising the created set of augmented image features; and
training a machine learning network with the set of augmented image features by using the training data set.

15. A computer-implemented method for generating augmented data, comprising:
accessing a first data file and a second data file, wherein the first data file and the second data file each include two or more dimensions;
transforming the first data file and the second data file to a first distribution of data points of the first data file and a second distribution of data points of the second data file;
performing a time-continuous transformation of the first distribution of data points of the first data file to the second distribution of data points of the second data file on a continuous path;
generating a set of path data points from the continuous path, wherein the continuous path includes a manifold of data distribution from the transformation of the first distribution of data points of the first data file to the second distribution of data points of the second data file; and
constructing an augmented dataset from the set of path data points.

16. The computer-implemented method of claim 15, wherein the first data file is a first image and the second data file is a second image.

17. The computer-implemented method of claim 16, further comprising:
converting the first image into a first pixel value space distribution and the second image into a second pixel value space distribution;
generating a set of minimized path data points by altering the first pixel value space distribution to render the second image pixel value space distribution by performing a minimization function;
creating a set of augmented images from the minimized path data points;
producing a training dataset wherein the dataset includes the augmented dataset; and
training a machine learning network with the augmented dataset by using the training dataset.

18. The computer-implemented method of claim 17, wherein the continuous path includes a manifold of pixel values.

19. The computer-implemented method of claim 17, further comprising:
calculating a distance using a divergence function, wherein the distance is a difference between a first pixel value space distribution location on the manifold and a second pixel value space distribution location on the manifold, and
wherein the converting of the first pixel value space distribution into the second pixel value space distribution is governed by a target image distribution.

20. The computer-implemented method of claim 19, wherein the target image distribution governs the transformation of the first pixel value space distribution by breaking the path into sub-step locations on the manifold.
